(19) United States
(12) Patent Application Publication
(10) Pub. No.: US 2009/0238676 A1
(43) Pub. Date: Sep. 24, 2009

(54) Accelerator for use in a wind power electrical generating system

(76) Inventor: Russel Hugh Marvin, Goshen, CT (US)

Correspondence Address: Ted Paulding, 10 Pennwood Lane, Weathersfield, CT, 06109, US

(21) Appl. No.: 12/077,556

(22) Filed: Mar. 20, 2008

(51) Int. Cl. F03D 1/00; F03D 11/04; F03D 7/02

(52) U.S. Cl. 415/4.3; 415/60; 416/117; 416/122; 416/9

(57) ABSTRACT

An accelerator for a wind power electrical generating system which mounts at least one wind turbine and which defines an air passageway capturing and delivering wind to the turbine. The accelerator comprises a cage-like support structure of thin sturdy members which defines in three-dimensional outline the air passageway. A cover which is mounted on and about the support structure in a floating relationship therewith may be injection-molded or thermo formed plastic. Connecting members between accelerators are provide with labyrinth seals.

### BACKGROUND OF THE INVENTION

Twin wind turbines mounted on a common rotatable support for rotation about horizontal axes are shown in the following U.S. Patents, disclosures incorporated herein by reference:
U.S. Pat. No. 4,021,140

Reference is also had to: U.S. patent application Ser. No. 11/820741 filed Jun. 19, 2007 entitled IMPROVED CONTROL SYSTEM FOR TWIN TURBINE WIND POWER GENERATING SYSTEM invented by Russel H. Marvin, hereby incorporated herein by reference,

U.S. Patent Application entitled IMPROVED GENERATOR OUTPUT CIRCUITRY FOR TWIN TURBINE WIND POWER GENERATING SYSTEM, filed Sep. 21, 2007, invented by Russel H. Marvin, hereby incorporated herein by reference, and

U.S. Patent Application entitled SYSTEM FOR OPERATING A GENERATOR AS A MOTOR IN A TURBINE WIND POWER GENERATING SYSTEM, filed Sep. 21, 2007, invented by Russel H. Marvin, hereby incorporated herein by reference.

U.S. Patent Application entitled IMPROVED INLET PASSAGEWAY AND SEALING IN A TURBINE WIND POWER GENERATING SYSTEM, filed Dec. 28, 2007, invented by Russel H. Marvin, hereby incorporated herein by reference.

Improved control systems for operating the apparatus of the aforesaid patents and improvements in airflow control and sealing of the turbines are disclosed in the aforementioned applications. The present application relates to an accelerator construction of lightweight high strength characteristics and durability under the severe conditions of temperature and humidity change in outdoor operation.

It is the general object of the present invention to provide a separator construction which meets the aforesaid criteria and which may be constructed at economic advantage.

### SUMMARY OF THE INVENTION

In fulfillment of the foregoing object and in accordance with the present invention an accelerator for use in a wind power electrical generating system has at least one variable speed wind turbine axis mounts the turbine for rotation about a horizontal axis and defines an outwardly open recess forming an airflow passageway. The airflow passageway captures and directs a stream of wind through an arcuate acceleration path to the wind turbine. The accelerator comprises a cage-like structure of thin lightweight supporting members connected together in a configuration which defines the three dimensional outline of the aforesaid airflow passageway. At least one thin but sturdy cover or skin member is disposed in overlaying relationship about and supported by the structure.

The cover member may be maintained in a floating relationship about the support structure with no connection to the structure or it may be attached positively to the support structure at a single area of attachment and remain otherwise in a floating relationship with the structure. The cover member may be an injection molded plastic with internal strengthening ribs or a substantially uniform thickness member produced in a thermo forming process.

The accelerators may be stacked vertically with a connecting member therebetween provided at joint areas with labyrinth seals.

The support structure may be a lightweight galvanized steel construction, aluminum or a composite carbon material.

Preferably, a plurality of cover member sections are mounted on the support structure in adjacent relationship with edge portions overlapping.

A presently preferred material for the cover member is polypropylene.

The accelerator may include a second wind turbine having an axis parallel with that of the first turbine but mounted on an opposite side of the accelerator. In this case, the airflow passageway bifurcates and follows arcuate paths diverging from a central location to supply each of the turbines with an accelerated airflow.

Viewed from the top the accelerator is generally cylindrical with the airflow passageway extending approximately 180 degrees and the turbines 180 degrees apart.

### DESCRIPTION OF THE DRAWINGS

FIG. 1 is a schematic illustration of a tower comprising a vertical stack of ten accelerators.

FIG. 2 is an enlarged schematic of a single accelerator showing its airflow passageway and twin turbines.

FIG. 3 is an enlarged view similar to FIG. 2 but from the top of the accelerator showing the direction of wind flow therethrough.

FIG. 4 is an enlarged schematic of a pair of vertically adjacent accelerators with the skin members somewhat transparent to show at least partially the support structures.

FIG. 5 is an enlarged view of a joint area between vertically adjacent accelerators.

FIG. 6 is an enlarged perspective view of an accelerator showing the support structure.

### DESCRIPTION OF PREFERRED EMBODIMENT

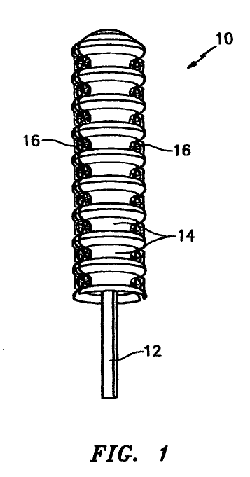

Referring particularly to FIG. 1, a tower comprising ten, 10 vertically stacked accelerator and turbine assemblies with a depending anchor 12. Each accelerator 14 mounts a pair of wind turbines 16, 16 each rotatable about a horizontal axis and disposed respectively on opposite sides of the accelerator 180 degrees apart.

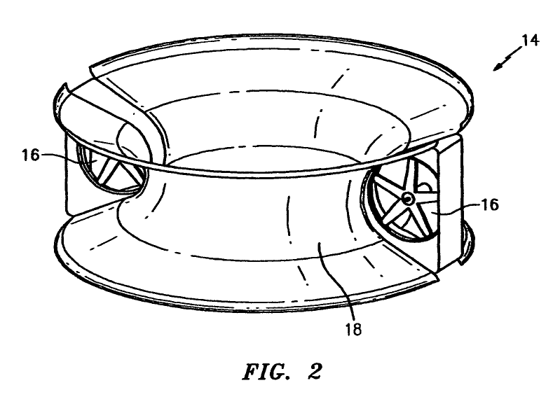

In FIG. 2 a single accelerator has an annular recess 18 which is open outwardly to receive the wind and which defines a bifurcated airflow passageway which captures the wind at the front of the unit and divides the flow for delivery to the turbines 16, 16. Due to the curvature of the passageway 18, the airflow is accelerated in passage from the front of the accelerator to the wind turbines.

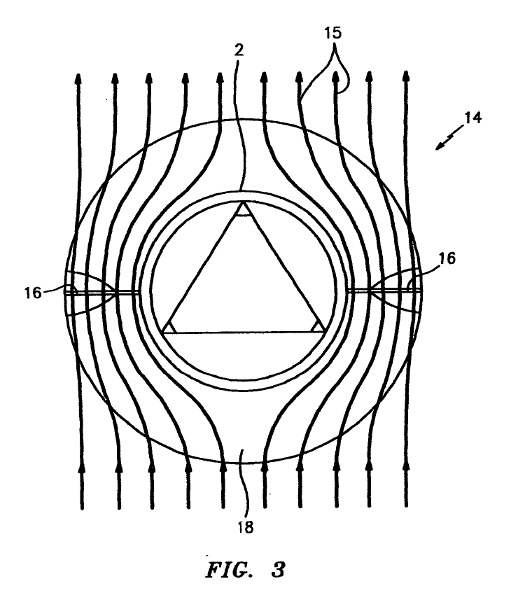

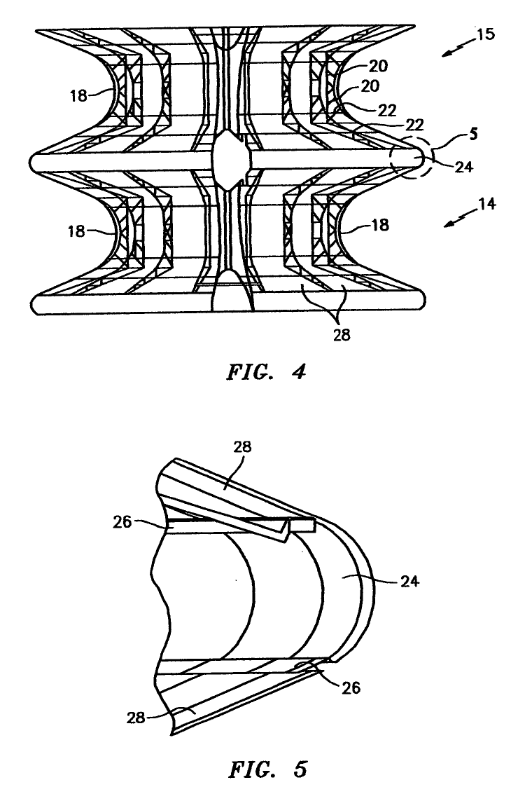

Arrows 15, 15 in FIG. 3 illustrate airflow through the passageway 18 and the turbines 16, 16.

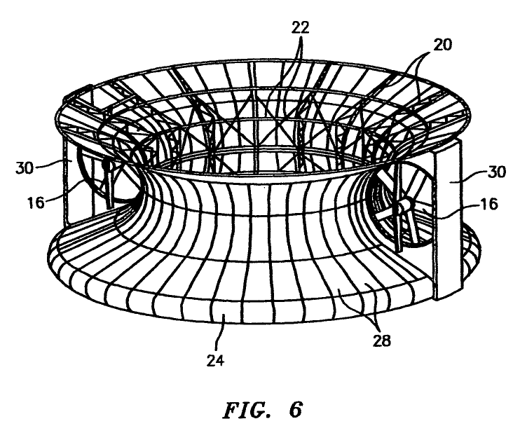

In FIG. 4 and 6 a support structure for the accelerator is illustrated at 20, 20 and 22, 22. Generally u-shaped thin support members are provided in an annular series arrangement to define the three-dimensional outline of the recess 18 which in turn defines the aforementioned air passageway. Connected with the u-shaped members are thin annular members 22, 22 which together with the members 20, 20 provide a lightweight but sturdy support structure. The u-shaped members 20, 20 may take the form of trusses as illustrated. Further structural members comprise mounting plates 30, 30 which extend vertically and which support he wind turbines 16, 16.

The support members 20, 20 and 22, 22 may be of galvanized steel, aluminum, or a carbon composite.

Supported on and about the support members 20, 20 and 22, 22 are a plurality of cover member sections 28. Each of the cover member sections 28, 28 takes a generally u-shaped form and the members are arranged in an adjacent relationship with edge portions overlapping. Alternatively, a single large covermember may be provided.

Attachment of the cover member to the support structure is limited with a completely floating arrangement between the member and the support structure presently preferred, Alternatively, the cover member may be attached to the support structure at a single area with the remaining portion of the member in a floating relationship with the support member.

Annular connecting members 24 interconnect vertically adjacent accelerators and joint areas between the members 24 and 28 are preferably provided with labyrinth seals 26, 26.

The cover member may be an injection-molded thermoplastic, optionally with internal strengthening ribs, or it may be of substantially uniform thickness throughout for production by a thermo forming process. Preferably the member is formed of polypropylene.

From the foregoing it will be apparent that a lightweight but sturdy accelerator construction has been provided with anticipated construction at economic advantage and durability over a long service life.

1. An accelerator for use in a wind power electrical generating system including at least one variable speed wind turbine rotatable about a substantially horizontal axis; said accelerator mounting the turbine for rotation about a horizontal axis and defining an outwardly open recess forming an airflow passageway which captures and directs a stream of wind through an arcuate acceleration path to the wind turbine, and said accelerator comprising a cagelike structure of thin lightweight supporting members connected together in a configuration which defines the three-dimensional outline of the aforesaid airflow passageway, and at least one thin but sturdy cover member disposed in overlaying relationship about and supported by said structure.

2. An accelerator as set forth in claim 1 wherein the cover member is maintained in a floating relationship about the support structure to accommodate differing thermal expansion rates.

3. A separator as set forth in claim 1 wherein the cover member is positively attached to said support structure at a single area of attachment and is otherwise in floating relationship with the structure.

4. An accelerator as set forth in claim 1 wherein the cover member is a thermoplastic and is injection-molded to a desired configuration to conform to the support structure.

5. An accelerator as set forth in claim 4 wherein a plurality of strengthening ribs are provided internally on the cover member.

6. An accelerator as set forth in claim 1 wherein the cover member is of a substantially uniform thickness throughout, and is a product of a thermo forming process.

7. An accelerator as set forth in claim 1 wherein one or more additional accelerators are provided in vertically stacked relationship with the joint between vertically adjacent cover members provided with labyrinth seals.

8. An accelerator as set forth in claim 1 wherein the support structure is constructed of thin lightweight steel members.

9. An accelerator as set forth in claim 8 wherein the steel is galvanized.

10. An accelerator as set forth in claim 1 wherein the support structure is constructed of lightweight aluminum members

11. An accelerator as set forth in claim 1 wherein the support structure is constructed of a material such as a carbon fiber composite.

12. An accelerator as set forth in claim 1 wherein a plurality of sections of cover members are provided and are mounted on the support in adjacent and abutting relationship.

13. An accelerator as set forth in claim 12 wherein the edge portions of the sections of the cover member are maintained in overlapping relationship.

14. An accelerator as set forth in claim 1 wherein the cover member is constructed of polypropylene.

15. An accelerator as set forth in claim 1 including a second wind turbine having an axis parallel with the first turbine but mounted on an opposite side of the accelerator, and wherein the airflow passageway follows arcuate paths diverging from a central location to supply each of the turbines with an accelerated airflow.

16. An accelerator as set forth in claim 15 wherein the accelerator viewed from the top is generally cylindrical with the airflow passageway extending through approximately 180 degrees with the turbines 180 degrees apart.

17. An accelerator as set forth in claim 15 wherein vertically adjacent accelerators are provided and wherein a connecting member between the separators is provided at joint areas with labyrinth seals.
